(19) United States
(12) Patent Application Publication
(10) Pub. No.: US 2026/0201152 A1
(43) Pub. Date: Jul. 16, 2026

(54) VULCANISABLE RUBBER MIXTURE, AND VULCANISED MATERIAL HAVING IMPROVED ROLLING PROPERTIES

(71) Applicant: Continental Reifen Deutschland GmbH, Hannover (DE)

(72) Inventors: Sebastian Finger, Halle (DE); Carla Recker, Hannover (DE)

(73) Assignee: Continental Reifen Deutschland GmbH, Hannover (DE)

(21) Appl. No.: 19/134,499

(22) PCT Filed: Dec. 7, 2023
(86) PCT No.: PCT/DE2023/200246

§ 371 Date: May 30, 2025

(30) Foreign Application Priority Data
Dec. 15, 2022 (DE) 10 2022 213 732.9

(51) Int. Cl. C08L 9/00; C08K 3/34; C08K 5/01; C08K 5/549

(52) U.S. Cl. CPC C08L 9/00; C08K 3/34; C08K 5/01; C08K 5/549

(57) ABSTRACT

A vulcanizable rubber compound including: a) one or more diene rubbers, b) one or more fillers selected from the group consisting of fillers having free OH groups at the filler surface, c) one or more organosilicon-modified resins, and d) one or more plasticizer oils in a combined part by weight in the range from 1 to 60 phr.

The invention relates to a vulcanizable rubber compound, to a vulcanizate producible therefrom and to a rubber product containing this vulcanizate. Also disclosed is the use of a corresponding vulcanizable rubber compound/corresponding vulcanizate in the production of rubber products to improve rolling properties.

The automobile industry is one of the industrial sectors that have faced fundamental challenges since the beginning of the 21st century while being defined by numerous technological innovations. Growing customer awareness of environmental issues such as emission profiles and resource efficiency requires new concepts for mobility. At the same time, the demand for improved vehicle features and the requirements in respect of driving safety are increasing. Meeting these challenges is not only an undertaking for the actual vehicle manufacturers. In practice, many of these issues are greatly influenced by the properties of tires, and so the optimization of tire properties is an important area of innovation.

A number of relevant properties of pneumatic vehicle tires, for example wet grip and abrasion resistance, are closely linked to the rubber composition of the tread. Therefore, the focus of many research efforts is on the optimization of the properties of the rubber composition and its additives.

Significant advances have been made in this field in recent decades. A key innovation here was the at least partial replacement of carbon black fillers by silicon-containing compounds, in particular silicon dioxide compounds, such as fumed silica, or silicates. It was found that particularly favorable properties can be obtained when the surface of silicon-containing compounds is modified by organosilanization, also known as organosilylation. To this end, the silicon-containing compounds are reacted with organosilicon compounds, in particular organyloxysilylorganic compounds, i.e., with compounds having at least one C—O—Si bond and at least one organic radical bonded by a Si—C bond. In the course of the chemical reaction, which is usually a condensation reaction, a modification by the organic radical of the organosilicon compounds occurs at the interface of the silicon-containing compounds. This organic radical can specifically influence the compatibility of the fillers in the rubber compound and the interactions with the rubber. Here, it is preferred in many cases if the organic radicals bear functional groups which can crosslink with the rubber compound in the course of vulcanization and thus increase the degree of crosslinking in the vulcanizate, and so organosilicon compounds are sometimes also referred to as so-called silane coupling agents. This principle is disclosed, for example, in DE 2536674 C3 or DE 2255577 A1.

The concept developed for the modification of silicon-containing compounds was subsequently adapted to resins as well. For instance, WO2018/191187 A1 proposed resins that were provided with a corresponding filler-reactive group in order to likewise allow bonding to the filler, and an advantageous influence on the physicochemical properties of the thus producible vulcanizable rubber compounds and the vulcanizates producible therefrom by vulcanization was likewise found. Such resins are sometimes also referred to by the inventors as organosilicon-modified resins.

Despite the fundamental advantages of using corresponding organosilicon-modified resins having a filler-reactive group, the use thereof in vulcanizable rubber compounds is sometimes also considered disadvantageous. In particular, it is perceived as disadvantageous in many cases that, although an improvement in the conflict of objectives between rolling resistance and wet grip can already be achieved in many cases, this improvement is still not sufficient in many cases. In this respect, there is a need to achieve an improved solution in respect of the conflict of objectives between wet grip and rolling resistance when proceeding from vulcanizable rubber compounds in which organosilicon-modified resins are used.

It was a primary object of the present invention to overcome or at least reduce the above-described disadvantages of the prior art.

In particular, it was an object of the present invention to provide a vulcanizable rubber compound and corresponding vulcanizates producible therefrom that have outstanding mechanical properties and optimally resolve in particular the conflict of objectives between good wet grip on the one hand and advantageous rolling resistance on the other hand. In this respect, it was desirable that the abrasion resistance of the vulcanizates should not be reduced or should only be negligibly reduced, and that ideally even an improvement in abrasion resistance should be achieved.

In this connection, it was an additional object of the present invention that the vulcanizable rubber compounds and vulcanizates to be provided should be producible as far as possible using production processes that are already in use today in the field of rubber processing.

It was a further object of the present invention to provide a corresponding rubber product comprising the vulcanizate to be provided.

It was a secondary object of the present invention to provide for the use of a corresponding vulcanizable rubber compound/corresponding vulcanizate in the production of rubber products to improve rolling properties.

The inventors of the present invention have now recognized that, surprisingly, the above-described objects can be achieved when specific amounts of a plasticizer oil, as defined in the claims, are used in vulcanizable rubber compounds comprising organosilicon-modified resins and fillers having free OH groups at the filler surface, in particular silicon-containing fillers.

The aforementioned objects are accordingly achieved by the subject matter of the invention, as defined in the claims. Preferred embodiments according to the invention will become apparent from the dependent claims and from the discussions hereunder.

In particularly preferred embodiments, embodiments that are referred to as preferred hereunder are combined with features of other embodiments that are referred to as preferred. Combinations of two or more of the embodiments that are referred to as particularly preferred hereunder are thus most particularly preferred. Likewise preferred are embodiments in which a feature of one embodiment that is referred to as preferred to a certain extent is combined with one or more further features of other embodiments that are referred to as preferred to a certain extent. Features of preferred vulcanizates, rubber products and uses will become apparent from the features of preferred vulcanizable rubber compounds.

Where the following text discloses for a compound constituent, for example for the diene rubbers or the organosilicon-modified resins, not only specific amounts/parts of said compound constituent but also preferred embodiments of the compound constituent, the text especially also discloses the specific amounts/parts of the preferred-embodiment compound constituents. Moreover, it is disclosed that, in the case of the corresponding specific total amounts/total parts of the compound constituents, at least some of the compound constituents may be of a preferred embodiment and it is especially also disclosed that preferred-embodiment compound constituents may in turn be present in the specific amounts/parts within the specific total amounts or total parts.

The invention relates to a vulcanizable rubber compound comprising:
a) one or more diene rubbers,
b) one or more fillers selected from the group consisting of fillers having free OH groups at the filler surface,
c) one or more organosilicon-modified resins, and
d) one or more plasticizer oils in a combined part by weight in the range from 1 to 60 phr.

Vulcanizable rubber compounds per se and typical components thereof and also typical production processes for obtaining corresponding vulcanizable rubber compounds are well known to a person skilled in the field of rubber processing.

In line with standard practice, the above-defined constituents of the vulcanizable rubber compound are each used as “one or more”. As is customary in the industry, the expression “one or more” refers to the chemical nature of the corresponding chemical compounds and not to the molar amount thereof. For example, the vulcanizable rubber compound may solely comprise SBR as diene rubber, which would mean that the vulcanizable rubber compound comprises a multiplicity of the corresponding molecules.

Where the following text indicates parts by weight, they are in many cases each indicated as combined parts by weight of the one or more components, as is customary in the industry, thereby expressing that the part by weight of the correspondingly formed components taken together meets the corresponding criteria. The measure phr (parts per hundred parts of rubber by weight) used here is the customary indication of quantity in the rubber industry for compound formulations and indicates the parts by weight of the components in the rubber compound based on the weight of the high-molecular-weight rubbers (GPC-determined weight-average molar mass Mw of greater than 60 000 g/mol) present in the rubber compound, with the combined part by weight of the high-molecular-weight rubbers in the rubber compound corresponding to 100 phr.

The vulcanizable rubber compound according to the invention comprises at least one diene rubber. In line with the understanding of a person skilled in the art, diene rubbers refer to rubbers that are obtained by (co)polymerization of dienes and/or cycloalkenes and thus have C═C double bonds either in the main chain or in the side groups. It can be considered to be an advantage of the vulcanizable rubber compound according to the invention that it is highly flexible with respect to the diene rubbers to be used, and so it is possible in principle to use all customary rubbers in the industry. In this respect, according to the inventors, preference is however given to a vulcanizable rubber compound according to the invention, wherein the one or more diene rubbers are selected from the group consisting of natural polyisoprene, synthetic polyisoprene, epoxidized polyisoprene, butadiene rubber, solution-polymerized styrene-butadiene rubber, emulsion-polymerized styrene-butadiene rubber, polynorbornene, ethylene-propylene-diene rubber, nitrile rubber, acrylate rubber, styrene-isoprene-butadiene terpolymer, butyl rubber and halobutyl rubber, wherein the one or more diene rubbers are preferably selected from the group consisting of natural polyisoprene (NR), synthetic polyisoprene (IR), butadiene rubber (BR), solution-polymerized styrene-butadiene rubber (SSBR) and emulsion-polymerized styrene-butadiene rubber (ESBR), wherein the one or more diene rubbers are particularly preferably selected from the group consisting of solution-polymerized styrene-butadiene rubber and emulsion-polymerized styrene-butadiene rubber. In this respect, preference is additionally or alternatively also given to a vulcanizable rubber compound according to the invention, wherein at least one of the diene rubbers, preferably all of the one or more diene rubbers, is a diene rubber which is end group-modified and/or modified along the chain, preferably a diene rubber which is end group-modified.

SBR, BR and IR/NR in particular have been found to be suitable diene rubbers for obtaining vulcanizable rubber compounds that can be converted by vulcanization into particularly effective vulcanizates. Thus, preference is initially given to a vulcanizable rubber compound according to the invention, wherein the vulcanizable rubber compound comprises styrene-butadiene rubber, preferably solution-polymerized styrene-butadiene rubber, as diene rubber, preferably in a combined part by weight of 30 phr or more, particularly preferably of 50 phr or more and most particularly preferably of 70 phr or more. Preference is additionally or alternatively given to a vulcanizable rubber compound according to the invention, wherein the vulcanizable rubber compound comprises butadiene rubber as diene rubber, preferably in a combined part by weight of 30 phr or more, particularly preferably of 50 phr or more and most particularly preferably of 70 phr or more. In turn, preference is additionally or alternatively given to a vulcanizable rubber compound according to the invention, wherein the vulcanizable rubber compound comprises natural polyisoprene and/or synthetic polyisoprene, preferably natural polyisoprene, as diene rubber, preferably in a combined part by weight in the range from 1 to 40 phr, particularly preferably in the range from 2 to 35 phr and most particularly preferably in the range from 5 to 30 phr.

Preference is additionally or alternatively given to a vulcanizable rubber compound according to the invention, wherein the diene rubber(s) has/have a weight-average molar mass Mw, measured by means of GPC, in the range from 200 000 to 5 000 000 g/mol and preferably in the range from 250 000 to 2 500 000.

For optimal adaptation of the physicochemical/mechanical properties of the producible vulcanizates to the particular application requirements, it has been found to be advantageous to mix two or more rubbers together. Preference is accordingly given to a vulcanizable rubber compound according to the invention, wherein the vulcanizable rubber compound comprises two or more, preferably three or more, different diene rubbers as diene rubber.

The vulcanizable rubber compound according to the invention comprises one or more fillers selected from the group consisting of fillers having free OH groups at the filler surface. A person skilled in the art will understand that these are fillers which, owing to the OH functionality at their surface, can undergo a condensation reaction with Si—O—R functionalities which are introduced by way of the organosilicon-modified resin in the context of the present invention. Besides other compounds, for example phyllosilicates such as kaolin, fillers having free OH groups at the filler surface are in particular amorphous silicon dioxide compounds. The vulcanizable rubber compound according to the invention accordingly preferably comprises one or more silicon-containing fillers particularly preferably selected from the group consisting of amorphous, i.e., noncrystalline, silicon dioxides. Among the amorphous silicon dioxides, especially the compounds which are historically also referred to in the German-speaking world as “Kieselsäuren” [silicic acids] or, on the basis of the English expression, as “Silika” [silicas] are of outstanding importance in the rubber industry, especially in the tire industry, and so the use of said “Kieselsäuren” as silicon-containing fillers is preferred for substantially all cases. Most particular preference is accordingly given to a vulcanizable rubber compound according to the invention, wherein the one or more silicon-containing fillers are selected from the group consisting of fumed silica and precipitated silica, particularly preferably precipitated silica.

Preference is fundamentally given to a vulcanizable rubber compound according to the invention, wherein the one or more silicon-containing fillers have a nitrogen surface area (BET surface area) according to DIN ISO 9277:2014-01 and DIN 66132:1975-07 in the range from 35 to 350 m²/g, preferably in the range from 45 to 260 m²/g and particularly preferably in the range from 100 to 220 m²/g. Preference is additionally or alternatively given to a vulcanizable rubber compound according to the invention, wherein the one or more silicon-containing fillers have a CTAB surface area according to ASTM D 3765-03 in the range from 35 to 350 m²/g, preferably in the range from 45 to 300 m²/g and particularly preferably in the range from 60 to 280 m²/g.

With respect to the amounts of filler that can be used, the inventors have found that the vulcanizable rubber compounds according to the invention advantageously exhibit outstanding results even for a high content of filler. However, according to the inventors, the solution identified in the context of the present invention exhibits the greatest advantages especially in the case of a medium content of filler. Preference is accordingly given to a vulcanizable rubber compound according to the invention, wherein the vulcanizable rubber compound comprises the one or more fillers having free OH groups at the filler surface, preferably the one or more silicon-containing fillers, in a combined part by weight in the range from 5 to 250 phr, preferably in the range from 20 to 180 phr, particularly preferably in the range from 30 to 160 phr and most particularly preferably in the range from 40 to 130 phr.

Besides the fillers having free OH groups at the filler surface that are to be used according to the invention, preferably the silicon-containing fillers, further fillers having no free OH groups at the filler surface may additionally also be present, thereby allowing specific adaptation of the properties of the vulcanizable rubber compound. Preference is given to a vulcanizable rubber compound according to the invention, wherein the vulcanizable rubber compound comprises one or more further fillers selected from the group consisting of fillers having no free OH groups at the filler surface, the combined part by weight of the further fillers being preferably in the range from 0.1 to 100 phr and particularly preferably in the range from 0.5 to 50 phr.

Besides the diene rubbers and the fillers and besides the resins and plasticizer oils further characterized hereinafter, what may be used in the vulcanizable rubber compounds according to the invention are further typical constituents which, for example, are used to influence the physicochemical properties, for example the processing and vulcanization properties, of the vulcanizable rubber compounds or the mechanical properties of the vulcanizates producible therefrom.

In this respect, an example that may be mentioned is a vulcanizable rubber compound according to the invention, wherein the vulcanizable rubber compound comprises one or more further additives, the further additives being preferably selected from the group consisting of coupling agents, methylene donors, antiaging agents, for example N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), 2,2,4-trimethyl-1,2-dihydroquinoline (TMQ), activators, for example zinc oxide and fatty acids, waxes, mastication aids, for example 2,2′-dibenzamidodiphenyldisulfide (DBD), and processing aids, the vulcanizable rubber compound preferably comprising the further additives in a combined part by weight in the range from 0.1 to 20 phr, preferably in the range from 0.5 to 15 phr and particularly preferably in the range from 1 to 10 phr.

Moreover, conventional resins may also be used in addition to the organosilicon-modified resins further specified hereinafter. In this respect, an example that may be mentioned is a vulcanizable rubber compound according to the invention, wherein the vulcanizable rubber compound comprises one or more further resins that are not organosilicon-modified resins, that are preferably plasticizer resins and/or reinforcer resins, preferably in a combined part by weight in the range from 0.5 to 50 phr, particularly preferably in the range from 1 to 40 phr and most particularly preferably in the range from 5 to 30 phr.

A person skilled in the field of rubber processing is easily able to distinguish resins from diene rubbers and any liquid polymer components, and in practice this is especially accomplished via the average molar mass or the glass transition temperature. An example that may be mentioned is a vulcanizable rubber compound according to the invention, wherein the one or more further resins have a glass transition temperature T_{g}, measured by means of DSC, of −20° C. or higher, preferably of −15° C. or higher and particularly preferably of −10° C. or higher. An example that may additionally or alternatively also be mentioned is a vulcanizable rubber compound according to the invention, wherein the one or more further resins have a weight-average molar mass Mw, measured by means of GPC, in the range from 200 to 50 000 g/mol, preferably in the range from 400 to 40 000 g/mol, particularly preferably in the range from 600 to 30 000 g/mol and most particularly preferably in the range from 800 to 20 000 g/mol.

With regard to vulcanization behavior, preference is given to a vulcanizable rubber compound according to the invention, wherein the vulcanizable rubber compound comprises 0.5 to 8.0 phr, preferably 0.8 to 6 phr and particularly preferably 1 to 4 phr of sulfur.

Preference is additionally or alternatively also given to a vulcanizable rubber compound according to the invention, wherein the vulcanizable rubber compound comprises further vulcanization constituents, the further vulcanization constituents being selected from the group consisting of crosslinkers, vulcanization retarders and vulcanization accelerators, for example thiazole accelerators, mercapto accelerators, sulfenamide accelerators, thiocarbamate accelerators, thiuram accelerators, thiophosphate accelerators, thiourea accelerators, xanthogenate accelerators or guanidine accelerators. Besides sulfur and sulfur donors, peroxidic crosslinkers may also be used for example. Suitable peroxidic crosslinkers include, for example, organic peroxides, such as dicumyl peroxide, di(2,4-dichlorobenzoyl) peroxide, tert-butyl peroxybenzoate, 1,1-di(tert-butylperoxy)-3,3,5-trimethylcyclohexane, butyl 4,4-di(tert-butylperoxy)valerate, 2,5-dimethyl-2,5-di(tert-butylperoxy)hexyne, di-tert-butyl peroxide, 2,5-dimethyl-2,5-di(tert-butylperoxy)hexane, di(2-tert-butyl-peroxyisopropyl)benzene or tert-butyl cumyl peroxide, and said crosslinkers may also be used in any combination with each other. Further alternatives used may, for example, be the crosslinking agents specified in WO 2018/191187 A1, paragraph [0094].

A particularly essential component of the vulcanizable rubber compounds according to the invention are the organosilicon-modified resins, which are sometimes also referred to as so-called organosilicon-modified resins. Examples of corresponding organosilicon-modified resins are disclosed, for example, in WO 2018/191187 A1.

These organosilicon-modified resins comprise the typical oligomeric or (co)polymeric backbone of conventional resins, but additionally have at least one filler-reactive group. Since there are ultimately no clear boundaries between oligomeric and polymeric compounds and since there is no advantage to the invention in making a distinction, the term “(co)polymeric backbone” or “(co)polymer chain” is used in both cases in the context of the invention, said term accordingly also including chains that could be referred to as a (co)oligomer chain.

With regard to the fillers having free OH groups at the filler surface that are used in rubber compounds according to the invention, the filler-reactive group must be a group that can react with such superficial free OH groups. According to the invention, these filler-reactive groups could in principle be a multiplicity of functional groups that allow the required reactivity with OH groups, for example isocyanate groups for the formation of carbamates. The filler-reactive group may be, for example, those with hydroxyl groups and/or ethoxy groups and/or epoxy groups and/or siloxane groups and/or amino groups and/or aminosiloxane and/or carboxyl groups and/or phthalocyanine groups and/or silane-sulfide groups. However, other modifications known to those skilled in the art, also known as functionalizations, are also suitable. Metal atoms may be a constituent of such functionalizations. However, according to the inventors, a silicon-based link is especially suitable for the vulcanizable rubber compounds according to the invention. In this respect, a person skilled in the art will understand that, in turn, the reaction relevant here is organosilanization, or organosilylation, and that the specific organosilicon-modified resins of the present invention are organosilicon-modified for this purpose, meaning that the organosilicon-modified resins are ultimately organyloxysilylorganic compounds and use can be made of the same functional groups that are known for this purpose from so-called silane coupling agents.

According to the inventors, with respect to the part by weight of these organosilicon-modified resins, preference is given to a vulcanizable rubber compound according to the invention, wherein the vulcanizable rubber compound comprises the one or more organosilicon-modified resins in a combined part by weight in the range from 0.5 to 60 phr, preferably in the range from 1 to 50 phr and particularly preferably in the range from 5 to 40 phr.

In this respect, the inventors have, however, also found in particular in their own experiments that the combination of plasticizer oils with organosilicon-modified resins is especially advantageous when the content of resin is relatively low, because particularly advantageous rebound resilience can be obtained, especially also consistently, whereas a decrease can occur in the combination of the relevant components with a high content of modified resin. Against this background, extreme preference is given to a vulcanizable rubber compound according to the invention, wherein the vulcanizable rubber compound comprises the one or more organosilicon-modified resins in a combined part by weight in the range from 0.1 to 20 phr, preferably in the range from 0.5 to 15 phr and particularly preferably in the range from 1 to 10 phr and/or wherein the vulcanizable rubber compound comprises the one or more organosilicon-modified resins in a combined part by weight of 17 phr or less, preferably of 13 phr or less, particularly preferably of 10 phr or less and most particularly preferably of 8 phr or less.

Preference is additionally or alternatively given to a vulcanizable rubber compound according to the invention, wherein the vulcanizable rubber compound comprises two or more different organosilicon-modified resins.

The inventors have successfully identified particularly suitable organosilicon-modified resins that, through their use, can achieve particularly advantageous rolling resistances and favorable wet grip behavior, thus advantageously resolving the relevant conflict of objectives.

Preference is initially given to a vulcanizable rubber compound according to the invention, wherein the one or more organosilicon-modified resins have a glass transition temperature T_{g}, measured by means of DSC, of −20° C. or higher, preferably of −15° C. or higher and particularly preferably of −10° C. or higher. Preference is additionally or alternatively also given to a vulcanizable rubber compound according to the invention, wherein the one or more organosilicon-modified resins have a weight-average molar mass Mw, measured by means of GPC, in the range from 200 to 60 000 g/mol, preferably in the range from 400 to 50 000 g/mol, particularly preferably in the range from 500 to 40 000 g/mol and most particularly preferably in the range from 600 to 35 000 g/mol. Determination of the number-average molar mass is effected by gel permeation chromatography according to DIN 55672-1:2016-03 (GPC with tetrahydrofuran as eluent, polystyrene standard; size exclusion chromatography).

Even though it is possible to modify the organosilicon-modified resins along the backbone, a terminal modification is considered by the inventors to be especially advantageous, assuming that the resultant terminal bonding to the filler is sterically advantageous. Preference is therefore given to a vulcanizable rubber compound according to the invention, wherein the one or more organosilicon-modified resins are terminally organosilicon-modified resins.

According to the inventors, the chemical structure of the organosilicon modification can be conveniently initially defined generically, in that the necessary silicon-containing functional group is bonded to the (co)polymer chain of the resin via a linker unit T. In this respect, preference is given to a vulcanizable rubber compound according to the invention, wherein the one or more organosilicon-modified resins have at least one structural element of formula II):

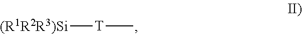

where the R¹, R² and R³ radicals are each independently a linear or branched organic group having 1 to 20 non-hydrogen atoms, the organic group of at least one of the R¹, R² and R³ radicals being bonded to the Si atom via an oxygen atom, where T is a linear or branched, preferably linear, organic connecting unit having 1 to 60, preferably 2 to 40 and particularly preferably 5 to 20 non-hydrogen atoms, via which the structural element of formula II) is bonded to the (co)polymer chain of the organosilicon-modified resin.

A person skilled in the art will understand that the role of the (R¹R²R³) Si group is that of bonding to the free OH groups at the filler surface; possible embodiments of the radicals are disclosed, for example, in WO 2019/105614 A1. Said (R¹R²R³) Si group may be chosen quite flexibly with respect to the R¹, R² and R³ radicals, but with the proviso that the organic group of at least one of the R¹, R² and R³ radicals is bonded to the Si atom via an oxygen atom. As a result, the specific organosilicon-modified resins are organyloxysilylorganic compounds, thereby expressing to a person skilled in the art that the organosilicon-modified resin is suitable for organosilanization. From the word element “organyloxysilyl”, it is expressed that the corresponding organosilicon-modified resins have at least one organic radical which is bonded to the central silicon atom of the (R¹R²R³) Si group via an oxygen atom. This organyloxy group, for example an alkoxy group, such as an ethoxy group, is the leaving group which can be released in the course of a condensation reaction at the surface of the filler having free OH groups at the filler surface, thus producing, for example, an Si—O—Si linkage in the case of silicon-containing fillers.

Even though it is fundamentally possible to use organosilicon-modified resins in which two of the three R¹, R² and R³ radicals are directly bonded to the central silicon via a carbon atom and which accordingly have only one leaving group, what are especially preferred in practice are organosilicon-modified resins having three, in most cases even identical, leaving groups, which in practice are commonly ethoxy groups that are released in the course of the reaction as ethanol. Preference is given in most cases to the corresponding embodiment with regard to the synthesis of the chemical compounds and to the production costs and with respect to the handling of the released leaving groups that can be removed from the compound comparatively easily. Moreover, corresponding organosilicon-modified resins having two or more leaving groups may at least potentially also bind with different particles of the filler.

Despite the high flexibility in the design of the R¹, R² and R³ radicals, preference is given in the light of the discussions above to any limitation in the direction of the particularly preferred (R¹R²R³) Si group having three alkoxy groups with, in most cases, a comparatively short chain. Preference is thus especially given to a vulcanizable rubber compound according to the invention, wherein the R¹, R² and R³ radicals are each independently linear or branched alkoxy groups or alkyl groups having 1 to 10 carbon atoms, at least one of the R¹, R² and R³ radicals being an alkoxy group. Preference is given to a vulcanizable rubber compound according to the invention, wherein the R¹, R² and R³ radicals are each independently linear alkoxy groups or alkyl groups. In this respect, preference is additionally or alternatively also given to a vulcanizable rubber compound according to the invention, wherein the R¹, R² and R³ radicals are each independently alkoxy groups or alkyl groups having 1 to 5 carbon atoms, preferably having 2 or 3 carbon atoms. Preference is additionally or alternatively also given to a vulcanizable rubber compound according to the invention, wherein at least two, preferably all, of the R¹, R² and R³ radicals are alkoxy groups. Particular preference is fundamentally given to a vulcanizable rubber compound according to the invention, wherein the R¹, R² and R³ radicals are identical. Most particular preference is given to a vulcanizable rubber compound according to the invention, wherein the R¹, R² and R³ radicals are ethoxy groups.

In the abovementioned definitions, organic groups and organic connecting units are defined. The term “organic” is clear to a person skilled in the art and means that these units are or can be part of an organic molecule and means in most cases that the non-hydrogen atoms are selected from the group of non-metals. In line with the understanding of a person skilled in the art, organic groups (e.g., —CH₃) are attached to other constituents of the particular chemical compound via one attachment point and organic connecting units (e.g., —CH₂—CH₂— or —CH₂—CHR^{x}—CH₂—, where R^{x} may in turn be an organic group for example) are attached to other constituents of the particular chemical compound via two attachment points.

The reference to “non-hydrogen atoms” in organic groups and connecting units is a convenience for a person skilled in the art and is familiar to them on the basis of their general knowledge. As a result, it can be expressed that organic connecting units/organic groups may not only be pure hydrocarbon units/hydrocarbon groups, but may also contain heteroatoms as a rule, meaning that the organic connecting units/organic groups also contain functional groups such as ester groups or ether groups. A person skilled in the art will automatically understand in this respect that, in addition to the “non-hydrogen atoms” defined above, hydrogen atoms may naturally also be present and will also be present in the vast majority of cases, and that they will, however, not be present in the chain because of their monovalent character, but will instead fill the valences remaining on the “non-hydrogen atoms”. In line with the understanding of a person skilled in the art, the expression “organic group having three non-hydrogen atoms” accordingly means, for example, that the organic group comprises, besides hydrogen atoms, three further non-hydrogen atoms.

In this respect, in line with the understanding of a person skilled in the art, what is preferred for substantially all embodiments is a vulcanizable rubber compound according to the invention, wherein the non-hydrogen atoms are selected from the group consisting of C, N, O, S, P, F, Cl and Br and are preferably selected from the group consisting of C, N, O and S. It is clear to a person skilled in the art that the definition of organic connecting units/organic groups results in an implicit functional restriction, in that the groups/connecting units are, of course, groups/connecting units which have a constitution which does not contradict any fundamental principles of chemistry, meaning that the abovementioned units do not, for example, solely consist of halides.

With regard to producing the organosilicon-modified resins in a time- and cost-efficient manner, the inventors propose the expedience of providing at least one heteroatom and preferably also yet further functional groups in the linker unit T. As a result, it is not just easier bonding of the organosilicon modification to the (co)polymer chain of the organosilicon-modified resin that is achieved. Rather, it has also been found in the experiments by the inventors that the properties of the organosilicon-modified resins and the effect thereof in the vulcanizable rubber compound can be influenced by the choice of functional groups and heteroatoms. Against this background, preference is given to a vulcanizable rubber compound according to the invention, wherein the one or more organosilicon-modified resins have at least one structural element of formula III):

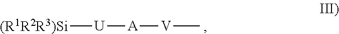

where the R¹, R² and R³ radicals are each independently a linear or branched organic group having 1 to 20 non-hydrogen atoms, the organic group of at least one of the R¹, R² and R³ radicals being bonded to the Si atom via an oxygen atom, where U is a linear or branched, preferably linear, organic connecting unit having 1 to 30, preferably 2 to 25 and particularly preferably 5 to 20 non-hydrogen atoms, U preferably comprising at least one functional group selected from the group consisting of amide groups, ester groups, carboxylic acid groups, ether groups and hydroxyl groups, particularly preferably selected from the group consisting of amide groups, ether groups and hydroxyl groups, where A is a heteroatom, preferably nitrogen or oxygen, particularly preferably oxygen, where V is a linear or branched, preferably linear, organic connecting unit having 1 to 20, preferably 2 to 15 and particularly preferably 5 to 10 non-hydrogen atoms, via which the structural element of formula III) is bonded to the (co)polymer chain of the organosilicon-modified resin, V being preferably an aromatic organic chain, V particularly preferably comprising an aromatic ring having 6 carbon atoms.

Most particularly preferably, according to the experiments by the inventors, the bonding to the (co)polymer chain of the organosilicon-modified resin is effected via an aromatic ring system. Specifically, preference is given to a vulcanizable rubber compound according to the invention, wherein the one or more organosilicon-modified resins have at least one structural element of formula IV):

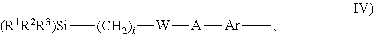

where the R¹, R² and R³ radicals are each independently a linear or branched organic group having 1 to 20 non-hydrogen atoms, the organic group of at least one of the R¹, R² and R³ radicals being bonded to the Si atom via an oxygen atom, where i is in the range from 1 to 20, preferably in the range from 2 to 15 and particularly preferably in the range from 3 to 10, where A is a heteroatom, preferably nitrogen or oxygen, particularly preferably oxygen, where Ar is an aromatic ring, preferably an aromatic ring having 6 carbon atoms, via which the structural element of formula III) is bonded to the (co)polymer chain of the organosilicon-modified resin, where W is a linear or branched, preferably linear, organic connecting unit having 2 to 20, preferably 3 to 15 and particularly preferably 4 to 10 non-hydrogen atoms, W comprising at least one functional group selected from the group consisting of amide groups, ester groups, carboxylic acid groups, ether groups and hydroxyl groups, preferably selected from the group consisting of amide groups, ether groups and hydroxyl groups.

In their own experiments, the inventors have successfully identified two structural elements for the organosilicon modification that, in cooperation with the specific plasticizer oils, achieve particularly good results in resolving the conflict of objectives between rolling resistance and wet grip. Specifically, particular preference is given to a vulcanizable rubber compound according to the invention, wherein the one or more organosilicon-modified resins have at least one structural element of formula V):

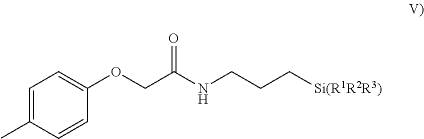

or formula VI):

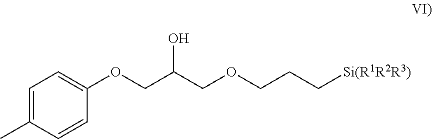

where the R¹, R² and R³ radicals are each independently a linear or branched organic group having 1 to 20 non-hydrogen atoms, the organic group of at least one of the R¹, R² and R³ radicals being bonded to the Si atom via an oxygen atom.

As explained above, the organosilicon-modified resins comprise a (co)polymer chain as the backbone. They are (co)polymers which are produced or producible from a specific monomer composition by polymerization. In line with the understanding of a person skilled in the art and with standard technological practice, it is expedient to define such (co)polymers in terms of the process of production and the starting materials used for production, since it is largely impossible to definitively define the corresponding materials in their entirety in a different way. In line with standard technological practice, producibility is specified in relation to the monomer composition, which, in line with the understanding of a person skilled in the art, comprises all monomeric constituents that are converted into monomer units of the (co)polymer chain in the course of polymerization. Accordingly, other constituents which may be present in the reaction mixture during polymerization, but which are not incorporated into the (co)polymer chain during polymerization, for example solvents, are not part of the monomer composition.

The starting point for further description of the (co)polymer chain is thus initially a vulcanizable rubber compound according to the invention, wherein the one or more organosilicon-modified resins comprise a (co)polymer chain producible by polymerization of a monomer composition.

Proceeding from this, preference is given to a vulcanizable rubber compound according to the invention, wherein the monomer composition comprises one or more polymerizable monomers selected from the group consisting of unsaturated aliphatic monomers and unsaturated aromatic monomers, preferably selected from the group consisting of unsaturated aromatic monomers, the monomer composition preferably consisting of said monomers. Preference is additionally or alternatively given to a vulcanizable rubber compound according to the invention, wherein the monomer composition comprises one or more polymerizable monomers selected from the group consisting of acrylates, methacrylates, terpenes, unsaturated fatty acids and vinyl aromatic compounds, the monomer composition preferably consisting of said monomers.

According to the inventors, particular preference is given to a vulcanizable rubber compound according to the invention, wherein the monomer composition comprises one or more polymerizable monomers selected from the group consisting of ethylenically unsaturated aromatic monomers, preferably α-methylstyrene and/or styrene, the monomer composition preferably consisting of said monomers. Particular preference is accordingly also given to a vulcanizable rubber compound according to the invention, wherein the one or more organosilicon-modified resins comprise a (co)polymer chain composed of polymerized α-methylstyrene and/or styrene, preferably α-methylstyrene and styrene.

The second essential constituent of the vulcanizable rubber compounds according to the invention is the plasticizer oils. According to the inventors, all typical plasticizer oils are in principle suitable for use in vulcanizable rubber compounds according to the invention. However, according to the inventors, preference is given to a vulcanizable rubber compound according to the invention, wherein the one or more plasticizer oils are selected from the group consisting of MES (mild extraction solvate), RAE (residual aromatic extract), TDAE (treated distillate aromatic extract), rubber-to-liquid oils (RTL) and biomass-to-liquid oils (BTL), preferably selected from the group consisting of MES, RAE and TDAE, particularly preferably TDAE.

An example that may be mentioned is a vulcanizable rubber compound according to the invention, wherein the one or more plasticizer oils are selected from the group consisting of mineral oil plasticizers, preferably aromatic, naphthenic and paraffinic mineral oil plasticizers.

Preference is given to a vulcanizable rubber compound according to the invention, wherein the one or more plasticizer oils are selected from the group consisting of plasticizer oils, preferably bio-based plasticizer oils, having a proportion by mass of naphthenic compounds of 2.5% or higher, preferably 5% or higher and particularly preferably 7.5% or higher, based on the mass of the plasticizer oil, and/or wherein the one or more plasticizer oils are selected from the group consisting of plasticizer oils, preferably bio-based plasticizer oils, having a proportion by mass of paraffinic compounds of 2.5% or higher, preferably 5% or higher and particularly preferably 7.5% or higher, based on the mass of the plasticizer oil, and/or wherein the one or more plasticizer oils are selected from the group consisting of plasticizer oils, preferably bio-based plasticizer oils, having a proportion by mass of aromatic compounds of 0.1% or higher, preferably 2.5% or higher and particularly preferably 5% or higher, based on the mass of the plasticizer oil.

With respect to the parts by mass, the inventors have been able to identify ranges with which good results can be reliably achieved in the conflict of objectives between rolling resistance and wet grip. Specifically, preference is given to a vulcanizable rubber compound according to the invention, wherein the vulcanizable rubber compound comprises the one or more plasticizer oils in a combined part by weight in the range from 2 to 50 phr, particularly preferably in the range from 5 to 45 phr and most particularly preferably in the range from 10 to 40 phr. According to the inventors, it is also especially expedient to provide specific minimum amounts in order to achieve as pronounced an effect as possible. Preference is therefore additionally or alternatively given to a vulcanizable rubber compound according to the invention, wherein the vulcanizable rubber compound comprises the one or more plasticizer oils in a combined part by weight in the range of 5 phr or more, preferably 10 phr or more and particularly preferably 15 phr or more.

The inventors have recognized that particularly advantageous results can be achieved when the content of plasticizer oil is specifically tailored to the content of organosilicon-modified resin. In this respect, according to the inventors, preference is given to a vulcanizable rubber compound according to the invention, wherein the quotient of the combined part by weight of the plasticizer oils divided by the combined part by weight of the organosilicon-modified resins is 5 or less, preferably 2.5 or less and particularly preferably 1.5 or less and/or wherein the quotient of the combined part by weight of the plasticizer oils divided by the combined part by weight of the organosilicon-modified resins is in the range from 0.8 to 5, preferably in the range from 1.0 to 4 and particularly preferably in the range from 1.2 to 3.

From the vulcanizable rubber compounds according to the invention, vulcanizates and rubber products can be produced in a customary manner. The corresponding process for producing a vulcanizate or a rubber product comprises, besides producing the vulcanizable rubber compound according to the invention, additionally, for example, the step of: vulcanizing the vulcanizable rubber compound according to the invention, preferably as part of a rubber blank, particularly preferably as part of an unvulcanized vehicle tire blank, for obtaining a vulcanizate, preferably as part of a rubber product, preferably as part of a pneumatic vehicle tire.

Here, the vulcanizable rubber compound according to the invention is vulcanized, for example, by the customary process in the tire industry, for example by sulfur-based crosslinking.

The invention accordingly also relates to a vulcanizate producible or produced by vulcanization of a vulcanizable rubber compound according to the invention. In this respect, preference is given to a vulcanizate according to the invention, wherein the vulcanizate is producible by vulcanization at a temperature in the range from 120° C. to 200° C., preferably in the range from 130° C. to 180° C.

The invention accordingly also relates to a rubber product comprising a vulcanizate according to the invention. An example that may be mentioned is a rubber product according to the invention, wherein the rubber product is selected from the group consisting of shoe soles, drive belts, hoses and belts. However, for substantially all cases, preference is given to a rubber product according to the invention, wherein the rubber product is a vehicle tire, preferably a pneumatic vehicle tire.

Lastly, also disclosed is the use of a vulcanizable rubber compound according to the invention and/or a vulcanizate according to the invention in the production of rubber products to improve rolling properties.

The invention and preferred embodiments of the invention will be explained and described in more detail hereunder with reference to experiments.

### A. Production of Vulcanizable Rubber Compounds:

The vulcanizable rubber compounds were produced in three stages in a laboratory mixer (300 mL, Brabender Mixer, CW Brabender GmbH & Co., South Hackensack, NJ, US) by the customary process in the rubber industry under customary conditions, comprising first of all, in a first mixing stage (basic mixing stage, rotor speed: 70 rpm, starting temperature: approx. 130° C., final temperature: approx. 149° C.), mixing all the constituents except the vulcanization system (sulfur and vulcanization-influencing substances). Adding the vulcanization system in the second stage (finishing mixing stage; rotor speed: 55 rpm, temperature: approx. 80° C.) yielded the vulcanizable rubber compound.

The substances used in this connection are listed in Table 1.

TABLE 1
Substances used

| | |
|---|---|
| Polymer | Solution-polymerized styrene-butadiene rubber (SSBR); |
| | NIPOL NS 612 |
| Filler | Precipitated silica; ULTRASIL VN 3 GR |
| Resin | 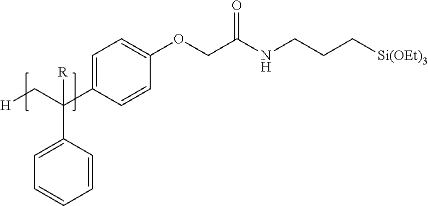 |
| | Degree of functionalization of approx. 50%; Mₙ = 699 g/mol |
| | (analogous to example 1.2 in WO 2018/191187 A1) |
| Plasticizer oil | Treated distillate aromatic extract; TDAE |
| Liq. BR | Liquid polybutadiene |
| Additive 1 | N-(1,3-dimethylbutyl)-N′-phenyl-p-phenylenediamine |
| Additive 2 | Wax |
| Additive 3 | ZnO |
| Additive 4 | Stearic acid |
| Silane | bis(triethoxysilylpropyl)disulfide (TESPD) |
| Vulcan. 1 | 1,3-Diphenylguanidine (DPG) |
| Vulcan. 2 | N-Cyclohexylbenzothiazoyl sulfenamide (CBS) |
| Vulcan. 3 | Sulfur |

Produced from all the vulcanizable rubber compounds by means of vulcanization (vulcanization conditions: t: 20 min, T: 160° C.) were standardized, vulcanized vulcanizates as test pieces.

### B. Determination of the Physicochemical Properties of the Vulcanizates:

Determined on the vulcanizates produced were the following physicochemical properties using the methods of determination described below:
Shore A hardness at room temperature (25° C.) according to DIN EN ISO 868:2003-10;
loss factor tan δ at 0° C. and 70° C. from temperature-dependent dynamic-mechanical measurement by means of an Eplexor according to DIN 53513:1990-03 (constant force, 10% compression, ±0.2% strain amplitude, frequency 10 Hz) and temperature at maximum loss factor (T @ tan δ max); and
abrasion at room temperature according to DIN ISO 4649:2021 (method A with nonrotating test pieces).

Loss factor tan δ (0° C.) serves as an indicator of wet grip of a tire. The higher the loss factor tan δ (0° C.), the better the wet grip properties. Loss factor tan δ (70° C.) serves as an indicator of rolling resistance of a tire, with a lower loss factor tan δ (70° C.) meaning lower rolling resistance. The greater the difference A tan δ (loss factor tan δ (0° C.)−loss factor tan δ (70° C.)), the more advantageous the vulcanizate in question with respect to the conflict of objectives between wet grip properties and rolling resistance.

### C. 1st Series of Tests:

In the 1st series of tests, ten vulcanizable rubber compounds were produced, the composition of which is specified in Table 2.

TABLE 2
Vulcanizable rubber compounds according to
the 1st series of tests (all data in phr)

| Constituents | V1 | V2 | V3 | V4 | V5 | V6 | E1 | E2 | E3 | E4 |
|---|---|---|---|---|---|---|---|---|---|---|
| Polymer | 100 | 100 | 100 | 100 | 100 | 100 | 100 | 100 | 100 | 100 |
| Filler | 60 | 60 | 60 | 60 | 60 | 60 | 60 | 60 | 60 | 60 |
| Resin | — | 15 | 30 | — | — | — | 15 | 15 | 30 | 30 |
| Plasticizer oil | — | — | — | 5 | 15 | 30 | 5 | 15 | 15 | 30 |
| Additive 1 | 2 | 2 | 2 | 2 | 2 | 2 | 2 | 2 | 2 | 2 |
| Additive 2 | 2 | 2 | 2 | 2 | 2 | 2 | 2 | 2 | 2 | 2 |
| Additive 3 | 2.5 | 2.5 | 2.5 | 2.5 | 2.5 | 2.5 | 2.5 | 2.5 | 2.5 | 2.5 |
| Additive 4 | 2.5 | 2.5 | 2.5 | 2.5 | 2.5 | 2.5 | 2.5 | 2.5 | 2.5 | 2.5 |
| Silane | 4.32 | 4.32 | 4.32 | 4.32 | 4.32 | 4.32 | 4.32 | 4.32 | 4.32 | 4.32 |
| Vulcan. 1 | 1 | 1 | 1 | 1 | 1 | 1 | 1 | 1 | 1 | 1 |
| Vulcan. 2 | 2 | 2 | 2 | 2 | 2 | 2 | 2 | 2 | 2 | 2 |
| Vulcan. 3 | 2 | 2 | 2 | 2 | 2 | 2 | 2 | 2 | 2 | 2 |

The material properties determined on the associated vulcanizates are summarized in Table 3.

TABLE 3
Material properties for the 1st series of tests

| | V1 | V2 | V3 | V4 | V5 | V6 | E1 | E2 | E3 | E4 |
|---|---|---|---|---|---|---|---|---|---|---|
| Hardness | 70.1 | 66.1 | 66.9 | 70.4 | 64.2 | 55.2 | 65.5 | 59.4 | 57.7 | 51.1 |
| (Sh. A; | | | | | | | | | | |
| RT) | | | | | | | | | | |
| tan δ | 0.199 | 0.280 | 0.347 | 0.206 | 0.192 | 0.186 | 0.289 | 0.276 | 0.317 | 0.314 |
| (0° C.) | | | | | | | | | | |
| tan δ | 0.089 | 0.101 | 0.161 | 0.088 | 0.084 | 0.090 | 0.102 | 0.093 | 0.107 | 0.100 |
| (70° C.) | | | | | | | | | | |
| Δ tan δ | 0.110 | 0.179 | 0.186 | 0.118 | 0.108 | 0.096 | 0.187 | 0.183 | 0.210 | 0.214 |
| T @ tan | −43 | −33 | −30 | −40 | −38 | −38 | −33 | −33 | −28 | −28 |
| δ max | | | | | | | | | | |
| Attritus/ | 100 | 118 | 154 | 90 | 89 | 68 | 115 | 124 | 145 | 169 |
| mm³ | | | | | | | | | | |

### D. 2nd Series of Tests:

In the 2nd series of tests, four vulcanizable rubber compounds were produced, the composition of which is specified in Table 4.

TABLE 4
Vulcanizable rubber compounds according to
the 2nd series of tests (all data in phr)

| Constituents | V7 | E5 | E6 | E7 |
|---|---|---|---|---|
| Polymer | 100 | 100 | 100 | 100 |
| Filler | 90 | 90 | 90 | 90 |
| Resin | — | 15 | 30 | 45 |
| Plasticizer oil | 30 | 30 | 30 | 30 |
| Additive 1 | 2 | 2 | 2 | 2 |
| Additive 2 | 2 | 2 | 2 | 2 |
| Additive 3 | 2.5 | 2.5 | 2.5 | 2.5 |
| Additive 4 | 2.5 | 2.5 | 2.5 | 2.5 |
| Silane | 6.48 | 6.48 | 6.48 | 6.48 |
| Vulcan. 1 | 1 | 1 | 1 | 1 |
| Vulcan. 2 | 2 | 2 | 2 | 2 |
| Vulcan. 3 | 2 | 2 | 2 | 2 |

The material properties determined on the associated vulcanizates are summarized in Table 5.

TABLE 5
Material properties for the 2nd series of tests

| | V7 | E5 | E6 | E7 |
|---|---|---|---|---|
| Hardness | 71.8 | 66.9 | 68.6 | 68.8 |
| (Sh. A; RT) | | | | |
| tan δ | 0.342 | 0.432 | 0.478 | 0.510 |
| (0° C.) | | | | |
| tan δ | 0.164 | 0.186 | 0.222 | 0.252 |
| (70° C.) | | | | |
| Δ tan δ | 0.178 | 0.246 | 0.256 | 0.258 |
| T @ tan δ | −41 | −36 | −33 | −28 |
| max | | | | |
| Attritus/ | 95 | 120 | 142 | 196 |
| mm³ | | | | |

### E. 3rd Series of Tests:

In the 3rd series of tests, eight vulcanizable rubber compounds were produced, the composition of which is specified in Table 6.

TABLE 6
Vulcanizable rubber compounds according to the 3rd series of tests (all data
in phr)

| Constituents | V8 | V9 | V10 | V11 | V12 | E8 | E9 | E10 |
|---|---|---|---|---|---|---|---|---|
| Polymer | 100 | 100 | 100 | 100 | 100 | 100 | 100 | 100 |
| Filler | 90 | 90 | 90 | 90 | 90 | 90 | 90 | 90 |
| Resin | — | — | 15 | 30 | 45 | 15 | 30 | 45 |
| Plasticizer oil | 30 | — | — | — | — | 30 | 30 | 30 |
| Liq. BR | — | 30 | 30 | 30 | 30 | — | — | — |
| Additive 1 | 2 | 2 | 2 | 2 | 2 | 2 | 2 | 2 |
| Additive 2 | 2 | 2 | 2 | 2 | 2 | 2 | 2 | 2 |
| Additive 3 | 2.5 | 2.5 | 2.5 | 2.5 | 2.5 | 2.5 | 2.5 | 2.5 |
| Additive 4 | 2.5 | 2.5 | 2.5 | 2.5 | 2.5 | 2.5 | 2.5 | 2.5 |
| Silane | 6.48 | 6.48 | 6.48 | 6.48 | 6.48 | 6.48 | 6.48 | 6.48 |
| Vulcan. 1 | 1 | 1 | 1 | 1 | 1 | 1 | 1 | 1 |
| Vulcan. 2 | 2 | 2 | 2 | 2 | 2 | 2 | 2 | 2 |
| Vulcan. 3 | 2 | 2 | 2 | 2 | 2 | 2 | 2 | 2 |

The material properties determined on the associated vulcanizates are summarized in Table 7.

TABLE 7
Material properties for the 3rd series of tests

| | V8 | V9 | V10 | V11 | V12 | E8 | E9 | E10 |
|---|---|---|---|---|---|---|---|---|
| Hardness | 71.8 | 69.3 | 63.4 | 63.4 | 64.3 | 66.9 | 68.6 | 68.8 |
| (Sh. A; | | | | | | | | |
| RT) | | | | | | | | |
| tan δ | 0.342 | 0.327 | 0.428 | 0.465 | 0.489 | 0.432 | 0.478 | 0.510 |
| (0° C.) | | | | | | | | |
| tan δ | 0.164 | 0.184 | 0.227 | 0.254 | 0.282 | 0.186 | 0.222 | 0.252 |
| (70° C.) | | | | | | | | |
| Δ tan δ | 0.178 | 0.143 | 0.201 | 0.211 | 0.207 | 0.246 | 0.256 | 0.258 |
| T @ tan δ | −41 | −43 | −41 | −38 | −36 | −36 | −33 | −28 |
| max | | | | | | | | |
| Attritus/ | 95 | 70 | 76 | 122 | 218 | 120 | 142 | 196 |
| mm³ | | | | | | | | |

### F Evaluation:

The results of the 1st, 2nd and 3rd series of tests show that vulcanizable rubber compounds according to the invention can yield vulcanizates which advantageously resolve the conflict of objectives between rolling resistance and wet grip.

For all vulcanizable rubber compounds according to the invention, the use of the plasticizer oils in combination with the organosilicon-modified resins yields vulcanizates having values for Δ tan δ, as an indicator of the conflict of objectives between rolling resistance and wet grip, that are consistently improved compared to those of the respective comparative system without plasticizer oil.

The 3rd series of tests clearly demonstrates that the inventive use of plasticizer oils is advantageous over other plasticizers such as liquid polybutadiene for resolving the conflict of objectives between wet grip and rolling resistance.

1. A vulcanizable rubber compound comprising:
a) one or more diene rubbers,
b) one or more fillers selected from the group consisting of fillers having free OH groups at the filler surface,
c) one or more organosilicon-modified resins, and
d) one or more plasticizer oils in a combined part by weight in the range from 1 to 60 phr.

2. The vulcanizable rubber compound as claimed in claim 1, wherein the vulcanizable rubber compound comprises the one or more fillers in a combined part by weight in the range from 5 to 250 phr.

3. The vulcanizable rubber compound as claimed in claim 1, wherein the one or more fillers are selected from the group consisting of amorphous silicon dioxides.

4. The vulcanizable rubber compound as claimed in claim 1, wherein the vulcanizable rubber compound comprises the one or more organosilicon-modified resins in a combined part by weight in the range from 0.5 to 60 phr.

5. The vulcanizable rubber compound as claimed in claim 1, wherein the one or more organosilicon-modified resins have at least one structural element of formula II): 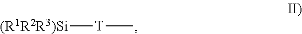
where the R¹, R² and R³ radicals are each independently a linear or branched organic group having 1 to 20 non-hydrogen atoms, the organic group of at least one of the R¹, R² and R³ radicals being bonded to the Si atom via an oxygen atom, where T is a linear or branched organic connecting unit having 1 to 60 non-hydrogen atoms, via which the structural element of formula II) is bonded to the (co)polymer chain of the organosilicon-modified resin.

6. The vulcanizable rubber compound as claimed in claim 1, wherein the one or more organosilicon-modified resins have at least one structural element of formula III): 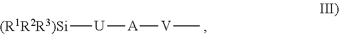
where the R¹, R² and R³ radicals are each independently a linear or branched organic group having 1 to 20 non-hydrogen atoms, the organic group of at least one of the R¹, R² and R³ radicals being bonded to the Si atom via an oxygen atom,
where U is a linear or branched organic connecting unit having 1 to 30 non-hydrogen atoms, where A is a heteroatom, where V is a linear or branched organic connecting unit having 1 to 20 non-hydrogen atoms, via which the structural element of formula III) is bonded to the (co)polymer chain of the organosilicon-modified resin.

7. The vulcanizable rubber compound as claimed in claim 1, wherein the one or more organosilicon-modified resins have at least one structural element of formula IV): 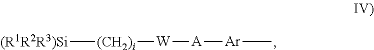
where the R¹, R² and R³ radicals are each independently a linear or branched organic group having 1 to 20 non-hydrogen atoms, the organic group of at least one of the R¹, R² and R³ radicals being bonded to the Si atom via an oxygen atom, where i is in the range from 1 to 20, where A is a heteroatom, where Ar is an aromatic ring via which the structural element of formula III) is bonded to the (co)polymer chain of the organosilicon-modified resin, where W is a linear or branched organic connecting unit having 2 to 20 non-hydrogen atoms, W comprising at least one functional group selected from the group consisting of amide groups, ester groups, carboxylic acid groups, ether groups and hydroxyl groups.

8. The vulcanizable rubber compound as claimed in claim 1, wherein the one or more plasticizer oils are selected from the group consisting of plasticizer oils having a proportion by mass of naphthenic compounds of 2.5% or higher, based on the mass of the plasticizer oil.

9. The vulcanizable rubber compound as claimed in claim 1, wherein the vulcanizable rubber compound comprises the one or more plasticizer oils in a combined part by weight in the range from 2 to 50 phr.

10. The vulcanizable rubber compound as claimed in claim 1, wherein the quotient of the combined part by weight of the plasticizer oils divided by the combined part by weight of the organosilicon-modified resins is in the range from 0.8 to 5.

11. A vulcanizate producible or produced by vulcanization of a vulcanizable rubber compound as claimed in claim 1.

12. A rubber product comprising a vulcanizate as claimed in claim 11.
